(19) United States
(12) Patent Application Publication
(10) Pub. No.: US 2003/0121172 A1
(43) Pub. Date: Jul. 3, 2003

(54) Gas distribution system for non-fluid bed, bulk process vessels

(76) Inventor: Thomas W. Kay, Scott Depot, WV (US)

Correspondence Address: WHYTE HIRSCHBOECK DUDEK S C, 111 EAST WISCONSIN AVENUE, SUITE 2100, MILWAUKEE, WI, 53202

(21) Appl. No.: 10/034,402

(22) Filed: Dec. 28, 2001

(51) Int. Cl. F26B 17/00

(52) U.S. Cl. 34/576; 34/583; 34/577

(57) ABSTRACT

A process and apparatus for the purging of excess hydrocarbons or monomer from polymer materials using a settled bed non-fluidized conditioning vessel having an internal gas distribution system which insures uniform gas distribution within the vessel and solids bed and provides for mass flow of solids. The gas distributor consists of several pipes or distribution legs configured parallel to the converging hopper walls of the vessel, having gas injection ports along their axial length. The injection ports are located so that the gas is evenly distributed across the cross section of the vessel at the level of the port. The size of the ports may be varied along with the spacing between ports such that specified pressure drops occur across any cross section of the vessel. The invention may be applied externally to a vessel such that the gas distribution legs enter through the vessel walls, or inserted entirely within the vessel, or even attached to the internal walls. The manifold and gas distribution legs are continuous and non-partitioned to allow a continuous gas stream to enter the vessel through the gas injection ports. The invention may also be used as a retrofit for existing bulk process vessels.

### BACKGROUND OF THE INVENTION

The present invention relates generally to gas distribution systems and bulk process vessels, and particularly, to a gas distribution system that promotes uniform distribution of gas within the vessel to provide exposure of the gas to all of the solids while not interfering with the desired mass flow of the solids.

There exist many applications in industry where a gas is introduced into a packed or semipacked bed of bulk solid materials. Such applications in the polymer field, for example, include the degassing of polymers of residual hydrocarbons dissolved in the polymer as it is removed from a polymer reaction system. Often, the purging of excess of hydrocarbons from polymer materials is conducted using a settled bed nonfluidized conditioning vessel. These processes generally require that the gas make intimate contact with each of the solid particles within the vessel, normally in a countercurrent flow pattern. It is general industry practice to introduce the gas via an internal cone arrangement or a vessel skirt arrangement. Both of these methods present the possibility of interference with the material flow pattern within the vessel. This results in unpredictable flows. Such undesirable results are increased with the use of vessels having conical shaped hoppers. Other structures employed for gas injection into the solids have taken forms that tend to create non-uniform exposure of the solids to the gas, as well as flow instabilities such as fluidization of localized regions, erratic flows, and pockets where the solids are not in motion.

In systems used in polymer processes, such as removal or purging of residual monomers from polymers, field experience indicates that the purge gas introduced in these conventional systems is not well distributed. Problems include poor monomer removal, excess gas consumption, as well as poor or uncertain solids flow patterns.

Therefore, there exists a need to provide a gas distribution system for use with a bed of bulk solid materials in a bulk solid vessel that provides uniform distribution of the gas within the vessel such that the solids received substantially the same exposure to the gas. In addition, it is also desirable to have a gas injection system that injects the gas into the vessels in such a manner such that the apparatus does not interfere with the desired mass flow of the solids.

### SUMMARY OF THE INVENTION

The present invention addresses the needs described above, and provides a uniform gas distribution assembly for use with a vessel having an interior for receiving a particular solid as part of a mass flow bulk process having a process gas supply. The assembly includes a substantially tubular gas manifold for supplying a gas into the interior of the vessel. The gas is supplied such that the gas is capable of contacting the particulate solid. The gas manifold is connected to the process gas supply. A plurality of gas distribution legs extends from the manifold, with the gas distribution legs converging at one end in the interior of the vessel. The gas distribution legs include a plurality of gas injection ports therein. The gas injection ports are capable of injecting gas flowing through the gas distribution legs into the interior of the vessel.

In another aspect of the invention, a gas manifold is external to the vessel and the gas distribution legs extend from the gas manifold and flows through the vessel to converge in the interior of the vessel.

In another aspect of the invention, the gas manifold and the gas distribution legs are located within the interior of the vessel.

In another aspect of the invention, the uniform gas distribution assembly is combined with a vessel to form a gas distribution system.

In another aspect of the invention, provided herein is a method of purging a monomer from a flowing polymer bulk solid material with a purge gas within a vessel having an interior. The method comprises: providing a substantially tubular gas manifold for supplying the purge gas into the interior of the vessel, the vessel having the flowing polymer bulk solid material containing the monomer within the interior; providing a plurality of continuous gas distribution legs extending from the manifold, the gas distribution legs converging at one end in the interior of the vessel, the gas distribution legs including a plurality of gas injection ports therein, the ports having one of a variable port size and a variable port spacing therebetween; introducing, via the gas injection ports, the purge gas flowing through the gas distribution legs into the interior of the vessel; and contacting, within the interior of the vessel, the purge gas with the flowing polymer bulk solid material containing the monomer, thereby substantially purging the polymer bulk solid material of the monomer.

Various other features, objects and advantages of the present invention will be made apparent from the following detailed description and the drawings.

### BRIEF DESCRIPTION OF THE DRAWINGS

The drawings illustrate at least one mode presently contemplated for carrying out the invention. In the drawings:

FIG. 1 is a perspective view of a gas distribution system in accordance with one aspect of the invention;

FIG. 2 is a partial cross section taken along line 2-2 of FIG. 1.;

FIG. 3 is a cross-sectional view taken along line 3-3 of FIG. 2;

FIG. 4 is a perspective view of another embodiment of a gas distribution system in accordance with one aspect of the invention;

FIG. 5 is a partial cross-sectional view taken along line 5-5 of FIG. 4;

FIG. 6 is an enlarged partial cross-sectional view of another embodiment according to one aspect of the present invention;

FIG. 7 is an enlarge partial sectional view of a portion taken along line 7-7 of FIG. 6;

FIG. 8 is a cross-sectional view taken along line 8-8 of FIG. 6;

FIG. 9 is a table illustrating sample test data of various gas tube styles in accordance with the present invention;

FIG. 10 is a graph illustrating the statistical treatment of the data of table of FIG. 9.

### DETAILED DESCRIPTION OF THE PREFERRED EMBODIMENT

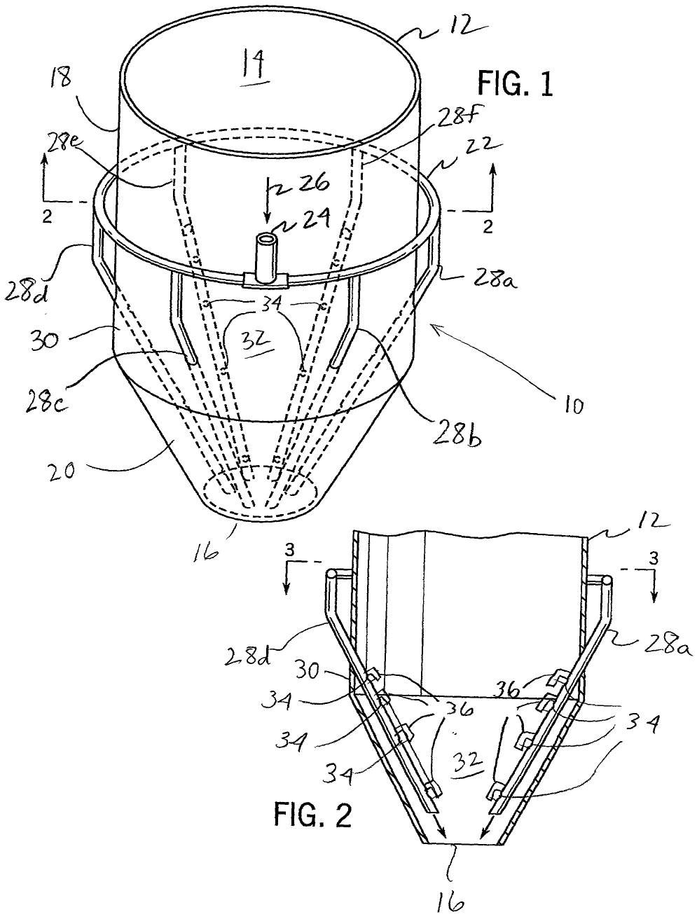

Referring to FIG. 1, the gas distribution system in the present invention is identified generally by the numeral 10. The system 10 is used with a bulk process vessel 12. Vessel 12 has an inlet 14 and an outlet 16. Vessel 12 may take any form, but in the embodiment shown, includes a cylindrical section 18 and a conical or frusto-conical section or hopper 20 having a decreasing diameter as it nears vessel exit 16. It is contemplated that vessel 12 is used in bulk solid material transfers. For example, vessel 12 may be used to transfer particulate solid polymers from a polymer reactor as part of a polymer reaction system or other polymer process. However, any suitable bulk solid material may be used in conjunction with the present invention. Additionally, the vessel 12 may take the shape of an inverted cone or of a vessel skirt-type arrangement. In a preferred embodiment, vessel 12 is a settled bed non-fluidized conditioning vessel. The gas distribution system 10 is used generally to remove or purge excess hydrocarbons or unreacted monomer such as an unpolymerized monomer from a flowing bulk solid material containing a polymer. The system can therefore be considered to de-gas the polymers of residual hydrocarbons dissolved in the polymer as the polymer is removed from a polymer reaction system. The invention is intended to introduce a gas (such as a purging gas) with each of the solids going through vessel 12 such that the gas makes intimate contact with each of the solid particles within the vessel 12. It is important that the introduction of the gas be uniform within the vessel such that all of the solids receive substantially the same exposure to the gas and that the gas is injected into the vessel 12 such that the gas distribution system 10 does not interfere with the desired mass flow of any solids travelling through vessel 12. It is also contemplated that gas distribution system 10 may be used as a retrofit for existing vessel structures and such retrofits may be accomplished by removing any structures within the vessel that would impede solid flows and attaching the appropriate gas distribution system. The gas distribution system 10 may also be applied in any conditioning vessel (for example, purging, heating and cooling) where a countercurrent gas flow is used. The desired mass flow pattern in vessel 12 will tend not to be disrupted as there are preferably no obstructions in the direction of flow. Further, the friction of material against vessel 12 is preferably unaffected by gas distribution system 10.

Gas distribution system 10 includes a gas manifold 22. Gas manifold 22 extends around vessel 12. Gas manifold 22 is preferably a tube or pipe arrangement that can convey gas supply via connection 24 from a gas supply in the direction indicated by arrow 26. Extending from, and integral with, gas manifold 22 are gas distribution legs 28a-f. In this embodiment, the gas distribution system or apparatus 20 is constructed such that the gas distribution legs 28a-f begin outside of bulk process vessel 12, but then enter through the outer wall 30 of cylindrical portion 18. However, any arrangement is contemplated, and any mode by which gas distribution legs 28a-f begin outside vessel 12 and substantially converge at the interior 32 of vessel 12 may be used.

Because one purpose of the gas distribution legs 28a-f is to introduce gas into the interior 32 of vessel 12, each gas distribution leg 28a-f includes a series of holes or gas ports 34 that are spaced along each of the gas distribution legs. Any placement of the holes is contemplated; however, it is preferred that the holes or gas ports 34 are non-uniformly spaced. In part this is due to the impact of the shape of the conical portion of the hopper portion. In theory, the velocity of the purge gas will be the volumetric flow rate of gas divided by the area in the flow channel. As the flow channel decreases, for example, as the hopper converges towards the outlet, proportionately less gas is injected into the flow channel, resulting in a uniform gas velocity across any cross section of vessel 12. This leads to improved uniformity in gas flow throughout vessel 12. Therefore, it is not necessary to space as many gas ports 34 as the gas distribution legs 28a-f approach the vessel exit 16. The size of gas ports 34 may also be varied in order to adjust the amount of gas flowing through the gas ports. Gas ports 34 are preferably positioned along each gas distribution leg such that the amount of gas emitted or injected is proportional to the cross-sectional area of the vessel at the level of the gas port 34. Generally, this implies that there will be fewer ports of equal diameter closer to the vessel outlet 16 than near the top entrance 14 of the vessel 12. However, one of ordinary skill in the art will recognize that various gas port arrangements and sizes are contemplated and are within the scope of the present invention. Preferably, gas ports 34 are positioned such that they are aimed towards a center axis of vessel 12. In other words, the gas port 34 is positioned away from the wall of vessel 12 that is closest to its respective gas distribution leg. In general, it is preferred that gas distribution legs 28a-f are continuous and non-partitioned such that there is free flow of gas from manifold 22 through each of the distribution legs 28a-f.

Referring now to FIG. 2, a section of vessel 12 is shown such that gas distribution legs 28a and d begin on the exterior of vessel 12, entering through wall 30 into interior 32 where they converge near exit 16 of vessel 12. Each of gas distribution legs includes a series of port caps or covers 36 covering each gas port 34. The cover is provided to help assure that solid particles flowing through vessel 12 do not fall by gravity into the port 34. This is particularly critical when there is no gas flow, and therefore no pressure against which solid may be prevented from entering gas distribution legs such as 28a and d. The port covers 36 may be employed in any suitable fashion and design, to the end that they prevent the solid material from entering the gas distribution legs and do not substantially prevent flow of the solid itself through the vessel.

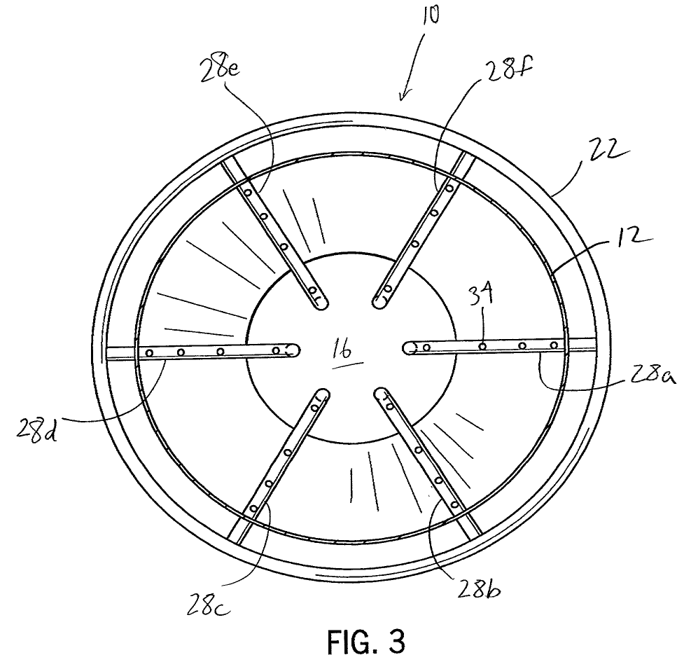

Referring now to FIG. 3, a sectional plane view is shown to see the extension of gas distribution legs 28a-f from manifold 22. Although six gas distribution legs are shown, it is desirable that at least four, preferably six, and more preferably eight gas distribution legs are included in the present invention gas distribution system 10. Although any number of gas distribution legs are contemplated, and with any desired effective spacing therebetween, in general the increased number of gas distribution legs allows a more full introduction of gas to any solid flowing within vessel 12. However, it is also desirable not to impede the flow of the solid by having more structure than is necessary to accomplish the introduction of any purge gas in the system.

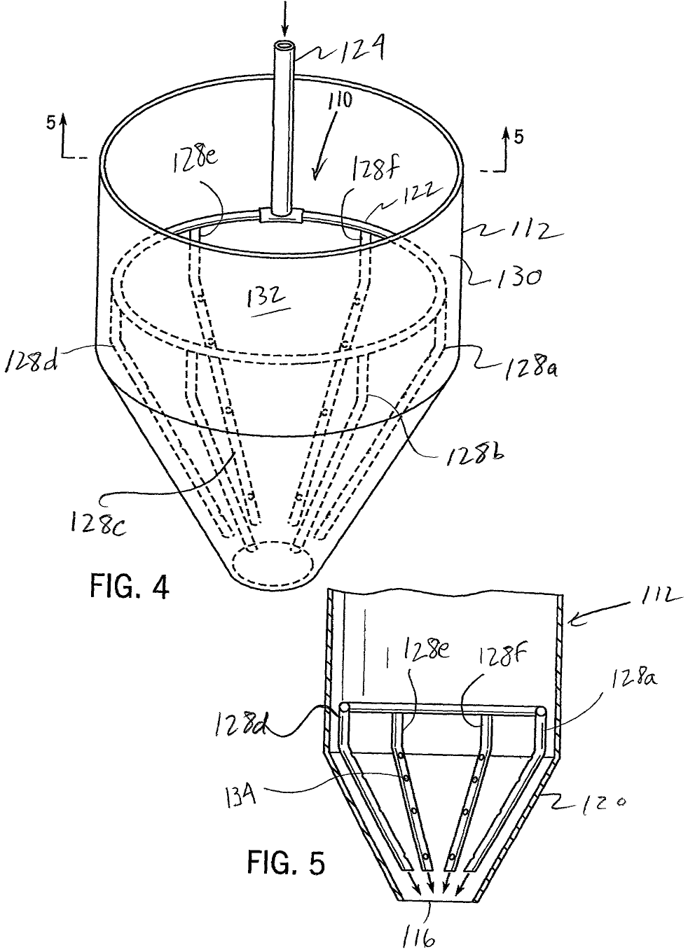

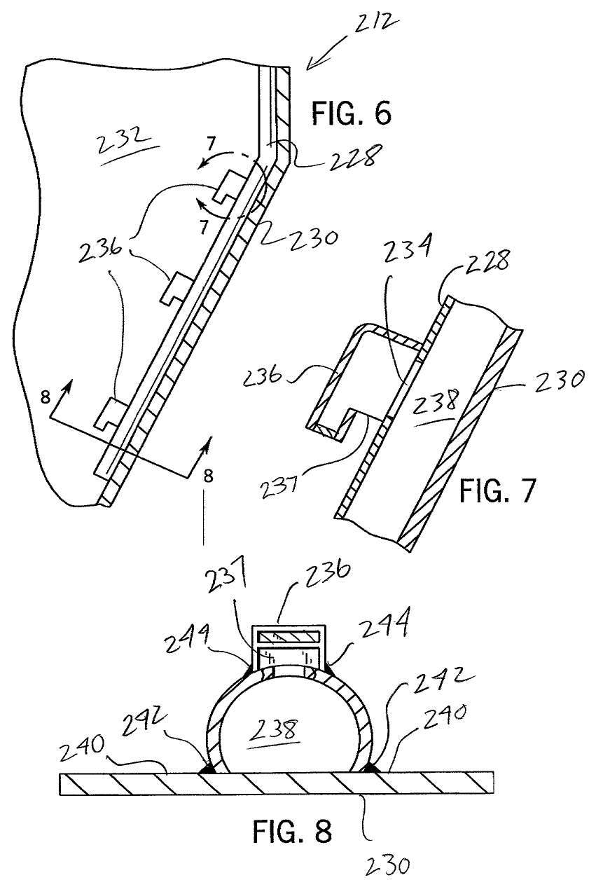

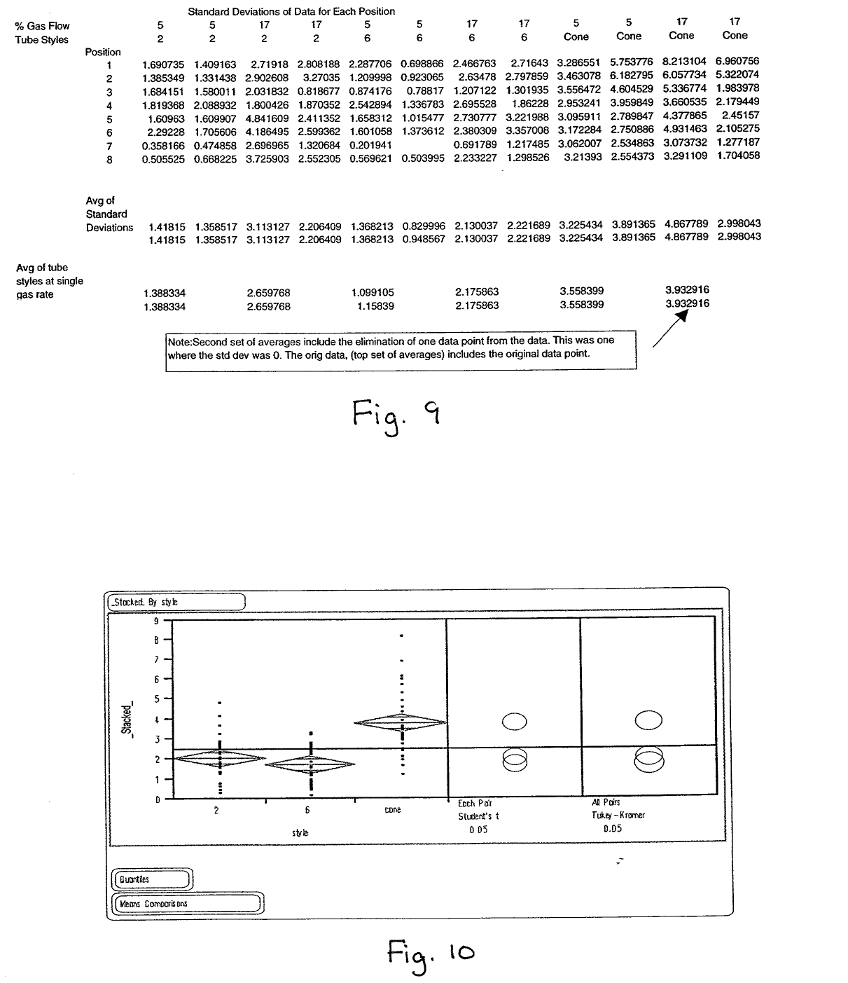

Referring now to FIG. 4, a second embodiment of the present invention is disclosed. The gas distribution system 110 includes a similar bulk process vessel 112 and connection 124 from a gas supply. However, in this embodiment, gas distribution 110 is placed entirely within the interior 132 of vessel 112. Gas manifold 122 begins on the inside and therefore is not necessary to have each of the gas distribution legs 128a-f go through the outer vessel wall 130 of vessel 112.

Referring now to FIG. 5, vessel 112 is shown such that gas distribution legs 128a, d, e and f are shown. It is also contemplated to vary the gas port 134 diameters to control the amount of gas emitted from each port in the distribution leg. In such a case, the ports may be equally spaced along the gas distribution leg. Preferably, the ports are positioned in a horizontal plane from one gas distribution leg to another, and the gas is distributed evenly along a cross section taken along the horizontal plane. Different combinations of spacing and gas port diameters may be used and varied such that the pressure drop from that port is taken into account with respect to the total gas flow and relative to the rest of the ports 34 on the gas distribution leg. Again, the total gas flow from each port is proportional to the cross-sectional area of the vessel at the port level. The gas distribution legs 128 converge towards the bottom exit 116 of vessel 112 with the result that gas is distributed all along and within conical or frusto-conical portion or hopper 120 of vessel 112.

Referring now to FIGS. 6-8, another embodiment of the invention is shown in enlarged fashion. In this instance, gas distribution leg 228 is located within the interior 232 of vessel 212 and is attached to outer vessel wall 230. In such a case, gas distribution leg 228 may even be configured as a half pipe or cylinder such that a plenum or chamber 238 is formed using vessel wall 230 as a portion of the gas distribution leg 228. In operation, gas flows through this plenum or chamber 238 and is injected through each of the gas ports 234, preferably in a direction substantially normal to a length of the respective gas distribution leg. Again, port caps or covers 236 may be used to prevent solid material from re-entering any of the ports 234. In the embodiment shown, the cap is shaped to allow gas to flow through open portion 237. Preferably, in this embodiment, gas distribution legs 228 are fixed or welded to the inner surface 240 of vessel 230 as by welds 242. Similarly, gas port cap 236 may be welded or otherwise affixed to gas distribution leg 228 as by welds 244.

### EXPERIMENTAL EVALUATION OF THE INVENTION

### Experiment 1

The initial experiment was carried out to determine if the conventional gas injection system, an inverted cone distributor, was effective or was contributing to maldistribution of gas in a purge vessel. The experimental set up consisted of a 2 foot diameter Plexiglas vessel equipped with a converging conical hopper. An inverted cone was positioned in the vessel at the vessel transition from the cylinder to the hopper in the same relative geometry as the commercial application. Granular polymer was loaded into the vessel and gas was injected under the cone distributor in increasing volume until the onset of fluidization as evidenced by the appearance of bubbles at the polymer surface.

Results indicated that the onset of fluidization occurred at gas velocities lower than would be expected by theoretical calculation. Further observation indicated that the gas distribution was not uniform at the surface of the polymer.

The initial design of the present invention was tested in the same manner. This design was equipped with gas injection ports equally spaced along the axis of each of the gas supply legs extending into the hopper. Results indicated that local fluidization still occurred, indicating non-uniform gas distribution, however, the configuration did allow for an observed mass flow pattern in the test vessel. The test was repeated combining the new distributor and the conventional inverted cone with no observable difference.

### Experiment 2

Experiments were carried out to determine the effectiveness gas distribution using a conventional inverted cone distribution system and comparing to the present invention in a 2 foot diameter model vessel. The control set up consisted of an inverted cone, positioned at the vessel knuckle between the converging hopper and the vertical cylinder. Gas, in this case, compressed air at ambient ˜25° C. was injected under the cone, with the vessel filled with a bed of granular polymer. The polymer had been heated to a temperature of approximately 50° C.-60° C. prior to the introduction to the vessel model.

The vessel was equipped with a series of thermocouples at 90° orientation from one another and at two different heights in the vessel. These were used to measure the local temperature at the thermocouple location. This temperature would be equal to the resin temperature at that location, and decline over time as the resin cooled. Areas of increased gas flow would cool at a faster rate than areas with little or no gas flow. Thus, by recording the rate of temperature change at each location, the distribution of the gas could be qualitatively measured.

FIG. 9 summarizes the data generated with the analysis of standard deviation from mean in gas distribution.

The tests in FIG. 9 were carried out with a control and two variations (styles 2 and 6) of the present invention.

The data were treated statistically in FIG. 10 in order to understand the results, which it clearly showed that there were in fact differences between the control and the experimental embodiment of the current invention, with the inventions showing improved gas distribution. It confirmed that the varying cross section for the conical hopper was an important design variable in that the port locations needed to be arranged such that gas flow increased moving upwards from the vessel outlet to the top of the hopper section.

### Experiment 3

This test utilized a velometer to measure the gas flow rate in the solids bed at various locations. The experimental gas distribution system from Experiment 2 was tested again against the control arrangement. The test design included gas injection port locations designed to inject more gas higher in the hopper, thus maintaining a constant superficial velocity in each cross section of the hopper. Analysis of the data again showed that using the current invention, the distribution of gas within the polymer bed was more uniform; however, due to difficulties with instrumentation, the specific data were not in themselves conclusive. The general trend of the data agreed with earlier experiments as described above.

Also provided herein is a method of purging a monomer from a flowing polymer bulk solid material with a purge gas within a vessel having an interior. The method comprises: providing a substantially tubular gas manifold for supplying the purge gas into the interior of the vessel, the vessel having the flowing polymer bulk solid material containing the monomer within the interior; providing a plurality of continuous gas distribution legs extending from the manifold, the gas distribution legs converging at one end in the interior of the vessel, the gas distribution legs including a plurality of gas injection ports therein, the ports having one of a variable port size and a variable port spacing therebetween; introducing, via the gas injection ports, the purge gas flowing through the gas distribution legs into the interior of the vessel; and contacting, within the interior of the vessel, the purge gas with the flowing polymer bulk solid material containing the monomer, thereby substantially purging the polymer bulk solid material of the monomer.

The steps of the methods described and claimed herein are set forth to provide the teachings of best mode and preferred embodiments of the invention, for purposes of clarity and particularity, and are not provided by way of limitation. The steps can be combined, divided, interchanged or otherwise rearranged, with such and other changes, alterations and modifications apparent to one of skill in the art and contemplated and within the scope of the present invention.

The present invention has been described in terms of the preferred embodiment, and it is recognized that equivalents, alternatives, and modifications, aside from those expressly stated, are possible and within the scope of the appending claims.

1. A uniform gas distribution assembly for use with a vessel having an interior for receiving a particulate solid as part of a mass flow bulk process having a process gas supply, the assembly comprising:
a substantially tubular gas manifold for supplying a gas into the interior of the vessel such that the gas is capable of contacting the particulate solid, the gas manifold connected to the process gas supply; and
a plurality of gas distribution legs extending from the manifold, the gas distribution legs converging at one end in the interior of the vessel, the gas distribution legs including a plurality of gas injection ports therein, the gas injection ports capable of injecting gas flowing through the gas distribution legs into the interior of the vessel.

2. The uniform gas distribution assembly of claim 1 wherein the gas manifold is external to the vessel and wherein the gas distribution legs extending from the gas manifold pass through the vessel and converge in the interior of the vessel.

3. The uniform gas distribution assembly of claim 1 wherein the gas manifold and the gas distribution legs are located within the interior of the vessel.

4. The uniform gas distribution assembly of claim 1 wherein the gas distribution legs are immediately adjacent to an internal wall of the vessel.

5. The uniform gas distribution assembly of claim 4 wherein the gas distribution legs are substantially parallel to the internal wall of the vessel.

6. The uniform gas distribution assembly of claim 1 wherein the gas distribution legs generally follow a contour of an internal wall of the vessel.

7. The uniform gas distribution assembly of claim 1 wherein the gas distribution legs include a plurality of cover portions connected to the gas distribution legs and positioned to at least substantially cover each of the gas injection ports in order to prevent solid particles from entering the gas injection ports from the interior of the vessel.

8. The uniform gas distribution assembly of claim 1 wherein the solid particles within the vessel receive substantially the same exposure to the gas injected from the gas injection ports.

9. The uniform gas distribution assembly of claim 1 wherein the injection of gas into the vessel through the gas distribution legs and gas injection ports does not substantially interfere with a desired mass flow of the solid.

10. The uniform gas distribution assembly of claim 1 wherein the gas injection ports are positioned along the gas distribution legs such that, from one gas distribution leg to another, the ports are positioned in a horizontal plane, and such that the gas is substantially evenly distributed across a cross section of the vessel when the gas passes through the ports, and where the cross section is taken along the horizontal plane.

11. The uniform gas distribution assembly of claim 1 wherein the gas manifolds supplies a purge gas into the interior of the vessel.

12. The uniform gas distribution assembly of claim 11 wherein the purge gas purges a monomer from the solid.

13. The uniform gas distribution assembly of claim 11 wherein the purge gas purges a hydrocarbon from the solid.

14. The uniform gas distribution assembly of claim 1 wherein the solid is a polymer.

15. The uniform gas distribution assembly of claim 1 wherein there are at least four (4) gas distribution legs.

16. The uniform gas distribution assembly of claim 1 wherein there are six (6) gas distribution legs.

17. The uniform gas distribution assembly of claim 1 wherein there are eight (8) gas distribution legs.

18. The uniform gas distribution assembly of claim 1 wherein the gas injection ports are non-uniformly spaced.

19. The uniform gas distribution assembly of claim 1 wherein the gas injection ports have non-uniform injection port diameters.

20. The uniform gas distribution assembly of claim 1 wherein the gas distribution legs are continuous.

21. The uniform gas distribution system of claim 1 wherein the gas distribution legs are non-partitioned.

22. The uniform gas distribution assembly of claim 1 wherein at least one of the gas distribution legs is attached to the vessel wall such that a gas flow channel is formed between a portion of the vessel wall and the gas distribution leg.

23. The uniform gas distribution assembly of claim 1 wherein the gas injection ports are not uniformly sized.

24. A uniform gas distribution system comprising:
a mass flow vessel having interior for receiving a particulate solid as part of a mass flow bulk process; and
a uniform gas distribution apparatus at least partially located within the vessel to inject gas into the vessel, the apparatus comprising:
a substantially tubular gas manifold for supplying a gas into the interior of the vessel such that the gas is capable of contacting the particulate solid, the gas manifold connected to the process gas supply; and
a plurality of gas distribution legs extending from the manifold, the gas distribution legs converging at one end in the interior of the vessel, the gas distribution legs including a plurality of gas injection ports therein, the gas injection ports capable of injecting gas flowing through the gas distribution legs into the interior of the vessel.

25. The gas distribution system of claim 24 wherein the gas injection ports are non-uniformly spaced.

26. The gas distribution system of claim 24 wherein the gas injection ports have non-uniform injection port diameters.

27. The gas distribution system of claim 24 wherein the gas distribution legs are continuous.

28. The gas distribution system of claim 24 wherein the gas distribution legs are non-partitioned.

29. The gas distribution assembly of claim 24 wherein at least one of the gas distribution legs is attached to the vessel wall such that a gas flow channel is formed between a portion of the vessel wall and the gas distribution leg.

30. The gas distribution system of claim 24 wherein the gas injection ports are not uniformly sized.

31. The gas distribution system of claim 24 wherein the vessel comprises a cylindrical portion and a substantially conical section connected to the cylindrical portion.

32. The gas distribution system of claim 24 wherein the gas injection ports are located on the gas distribution legs so as to introduce the gas flowing the gas injection ports towards a central section of the vessel.

33. The gas distribution system of claim 24 wherein the gas distribution legs converge from an outer diameter of the vessel to a central outlet of the vessel.

34. The gas distribution system of claim 24 wherein the gas injection ports inject less gas as the gas distribution legs approach the outlet of the vessel.

35. The gas distribution system of claim 24 wherein the distance between gas injection ports along each of the gas distribution legs is varied.

36. The gas distribution system of claim 24 wherein the gas injection ports are sized to vary the gas flowing from the gas distribution legs through the gas injection ports.

37. The gas distribution system of claim 24 wherein the gas injection ports are oriented such that gas flows through the ports in a direction that is substantially normal to a length of the respective gas distribution leg.

38. The gas distribution system of claim 24 wherein the gas injection ports are oriented facing towards a center of the vessel.

39. The gas distribution system of claim 24 wherein the gas distribution legs have a substantially constant pressure drop along each of the gas distribution legs.

40. The gas distribution system of claim 24 wherein the gas is substantially evenly distributed to each of the gas distribution legs.

41. The gas distribution system of claim 24 wherein the gas manifold is external to the vessel and wherein the gas distribution legs extending from the gas manifold pass through the vessel and converge in the interior of the vessel.

42. The gas distribution system of claim 24 wherein the gas manifold and the gas distribution legs are located within the interior of the vessel.

43. The gas distribution system of claim 24 wherein the gas distribution legs are immediately adjacent to an internal wall of the vessel.

44. The gas distribution system of claim 24 wherein the gas distribution legs are substantially parallel to the internal wall of the vessel.

45. The gas distribution system of claim 24 wherein the gas distribution legs generally follow a contour of an internal wall of the vessel.

46. The gas distribution system of claim 24 wherein the gas distribution legs include a plurality of cover portions connected to the gas distribution legs and positioned to at least substantially cover each of the gas injection ports in order to prevent solid particles from entering the gas injection ports from the interior of the vessel.

47. The gas distribution system of claim 24 wherein the solid particles within the vessel receive substantially the same exposure to the gas injected from the gas injection ports.

48. The gas distribution system of claim 24 wherein the injection of gas into the vessel through the gas distribution legs and gas injection ports does not substantially interfere with a desired mass flow of the solid.

49. The gas distribution system of claim 24 wherein the gas injection ports are positioned along the gas distribution legs such that, from one gas distribution leg to another, the ports are positioned in a horizontal plane, and such that the gas is substantially evenly distributed across a cross section of the vessel when the gas passes through the ports, and where the cross section is taken along the horizontal plane.

50. The gas distribution system of claim 24 wherein the gas manifolds supplies a purge gas into the interior of the vessel.

51. The gas distribution system of claim 24 wherein the purge gas purges a monomer from the solid.

52. The gas distribution system of claim 50 wherein the purge gas purges a hydrocarbon from the solid.

53. The gas distribution system of claim 24 wherein the solid is a polymer.

54. The gas distribution system of claim 24 wherein there are at least four (4) gas distribution legs.

55. The gas distribution system of claim 24 wherein there are six (6) gas distribution legs.

56. The gas distribution system of claim 24 wherein there are eight (8) gas distribution legs.

57. A retrofit for a bulk process vessel, the retrofit comprising:
a substantially tubular gas manifold for supplying a gas into an interior of the vessel such that the gas is capable of contacting the particulate solid, the gas manifold connected to the process gas supply; and
a plurality of gas distribution legs extending from the manifold, the gas distribution legs converging at one end in the interior of the vessel, the gas distribution legs including a plurality of gas injection ports therein, the gas injection ports capable of injecting gas flowing through the gas distribution legs into the interior of the vessel;
wherein the retrofit can be used in combination with a polymer gas injection system to purge one of a hydrocarbon and a monomer from a polymer bulk solid.

58. A method of purging a monomer from a flowing polymer bulk solid material with a purge gas within a vessel having an interior, the method comprising:
providing a substantially tubular gas manifold for supplying the purge gas into the interior of the vessel, the vessel having the flowing polymer bulk solid material containing the monomer within the interior;
providing a plurality of continuous gas distribution legs extending from the manifold, the gas distribution legs converging at one end in the interior of the vessel, the gas distribution legs including a plurality of gas injection ports therein, the ports having one of a variable port size and a variable port spacing therebetween;
introducing, via the gas injection ports, the purge gas flowing through the gas distribution legs into the interior of the vessel; and
contacting, within the interior of the vessel, the purge gas with the flowing polymer bulk solid material containing the monomer, thereby substantially purging the polymer bulk solid material of the monomer.
